(19) United States
(12) Patent Application Publication
(10) Pub. No.: US 2024/0155414 A1
(43) Pub. Date: May 9, 2024

(54) COMMUNICATION METHOD, USER EQUIPMENT, AND BASE STATION

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/412,138

(22) Filed: Jan. 12, 2024

Related U.S. Application Data
(63) Continuation of application No. PCT/JP2022/027046, filed on Jul. 8, 2022.

(30) Foreign Application Priority Data
Jul. 14, 2021 (JP) 2021-116738

(51) Int. Cl. H04W 28/02; H04W 28/10

(52) U.S. Cl. CPC H04W 28/0268; H04W 28/10; H04W 80/06

(57) ABSTRACT

A communication method used in a mobile communication system includes: a step S1 of configuring, by a base station, a user equipment with a first communication path and a second communication path associated with the first communication path as communication paths to be established between the base station and the user equipment; a step S2 of mapping, by an entity in a predetermined layer of the user equipment, first data belonging to a data flow to the first communication path; a step S3 of mapping, by the entity, to the second communication path, second data belonging to the data flow and being assigned a higher priority than the first data; and a step S4 of transmitting, by the user equipment to the base station, the second data mapped to the second communication path with priority over the first data mapped to the first communication path.

### RELATED APPLICATIONS

The present application is a continuation based on PCT Application No. PCT/JP2022/027046, filed on Jul. 8, 2022, which claims the benefit of Japanese Patent Application No. 2021-116738 filed on Jul. 14, 2021. The content of which is incorporated by reference herein in their entirety.

### TECHNICAL FIELD

The present disclosure relates to a communication method, a user equipment, and a base station used in a mobile communication system.

### BACKGROUND OF INVENTION

The 3GPP (3rd Generation Partnership Project) has defining technical specifications for New Radio (NR), which is a 5th Generation (5G) radio access technology. New Radio (NR) is capable of wide-band transmission via a high frequency band as opposed to Long Term Evolution (LTE), which is a 4th Generation (4G) radio access technology.

Although NR has the capability of transmitting Transmission Control Protocol (TCP) data at a high throughput in a downlink, a problem with NR is that when transmission of a TCP Acknowledgement (Ack) in an uplink is delayed due to how TCP works, the throughput of the downlink decreases. Accordingly, transmitting the TCP Ack with priority over other data in the uplink has been proposed (see Non-Patent Document 1).

### CITATION LIST

### Non-Patent Literature

Non-Patent Document 1: 3GPP Contribution RWS-210226, “TCP boosting”

### SUMMARY

In a first aspect, a communication method is used in a mobile communication system. The communication method includes: configuring, by a base station, a user equipment with a first communication path and a second communication path associated with the first communication path as communication paths to be established between the base station and the user equipment; mapping, by an entity in a predetermined layer of the user equipment, first data belonging to a data flow to the first communication path; mapping, by the entity, to the second communication path, second data belonging to the data flow and being assigned a higher priority than the first data; and transmitting, by the user equipment to the base station, the second data mapped to the second communication path with priority over the first data mapped to the first communication path.

In a second aspect, a user equipment is used in a mobile communication system. The user equipment includes: a receiver configured to receive, from a base station, information indicating configuration of a first communication path and a second communication path associated with the first communication path as communication paths to be established between the base station and the user equipment; a controller configured to map, to the first communication path, first data belonging to a data flow and to map, to the second communication path, second data belonging to the data flow and being assigned a higher priority than the first data; and a transmitter configured to transmit, to the base station, the second data mapped to the second communication path with priority over the first data mapped to the first communication path.

In a third aspect, a base station is used in a mobile communication system. The base station includes: a controller configured to configure a user equipment with a first communication path and a second communication path associated with the first communication path as communication paths to be established between the base station and the user equipment; and a receiver configured to receive, from the user equipment, first data mapped to the first communication path and second data mapped to the second communication path. The first data and the second data are data belonging to the same data flow. The second data mapped to the second communication path is transmitted from the user equipment with priority over the first data mapped to the first communication path.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating Quality of Service (QoS) control in the mobile communication system according to an embodiment.

FIG. 7 is a diagram illustrating an example of processing of layers in the protocol stack of the radio interface of a user plane.

FIG. 8 is a diagram illustrating operations of the mobile communication system according to an embodiment.

FIG. 9 is a diagram illustrating an SDAP entity according to a first example.

FIG. 10 is a diagram illustrating operations of a gNB and a UE according to the first example.

FIG. 11 is a diagram illustrating a PDCP entity according to a second example.

FIG. 12 is a diagram illustrating operations of a gNB and a UE according to the second example.

### DESCRIPTION OF EMBODIMENTS

However, technical specifications of current 3GPP standards have not introduced a mechanism to transmit a TCP Ack with priority over other data in an uplink. Thus, there is room for improvement in realizing high throughput in a mobile communication system.

An object of the present disclosure is to realize high throughput in the mobile communication system.

A mobile communication system according to an embodiment is described with reference to the drawings. In the description of the drawings, the same or similar parts are denoted by the same or similar reference signs.

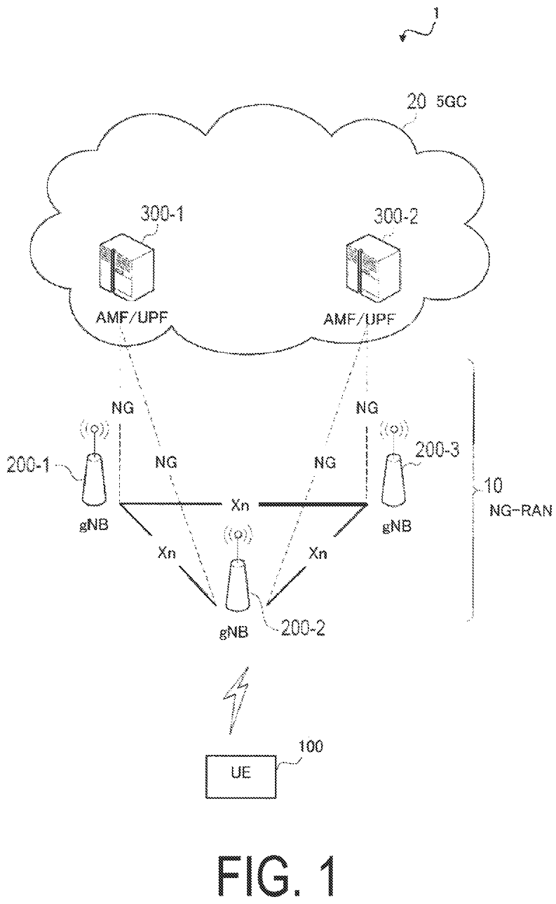

First, with reference to FIGS. 1 to 7, a configuration of a mobile communication system according to an embodiment will be described. FIG. 1 is a diagram illustrating a configuration of the mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. A 6th Generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20.

The UE 100 is a mobile wireless communication apparatus. The UE 100 may be any apparatus as long as the UE 100 is used by a user. Examples of the UE 100 include a mobile phone terminal (including a smartphone), or a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

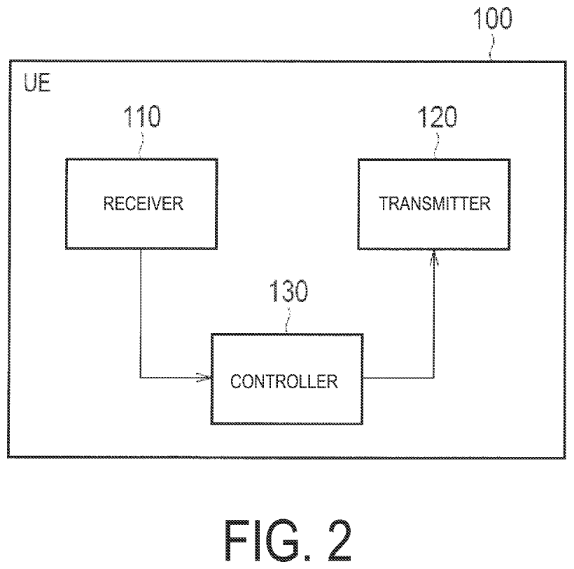

FIG. 2 is a diagram illustrating a configuration of the user equipment (UE) 100 according to an embodiment. The UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

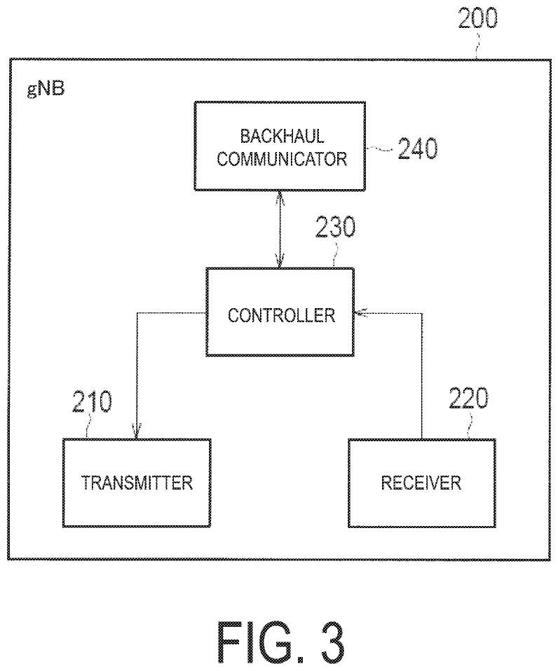

FIG. 3 is a diagram illustrating a configuration of the base station (gNB) 200 according to an embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

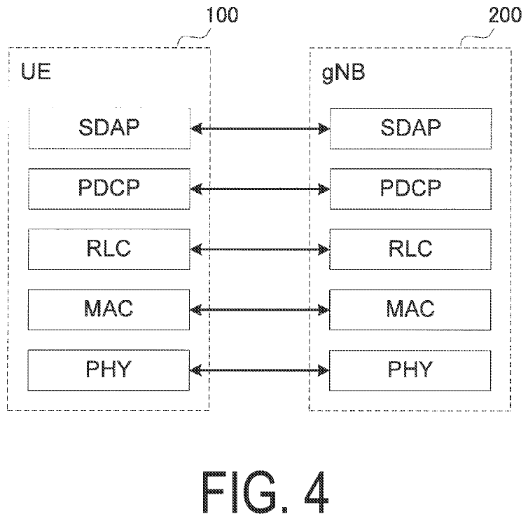

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs priority control of data, retransmission processing through hybrid ARQ (HARQHybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

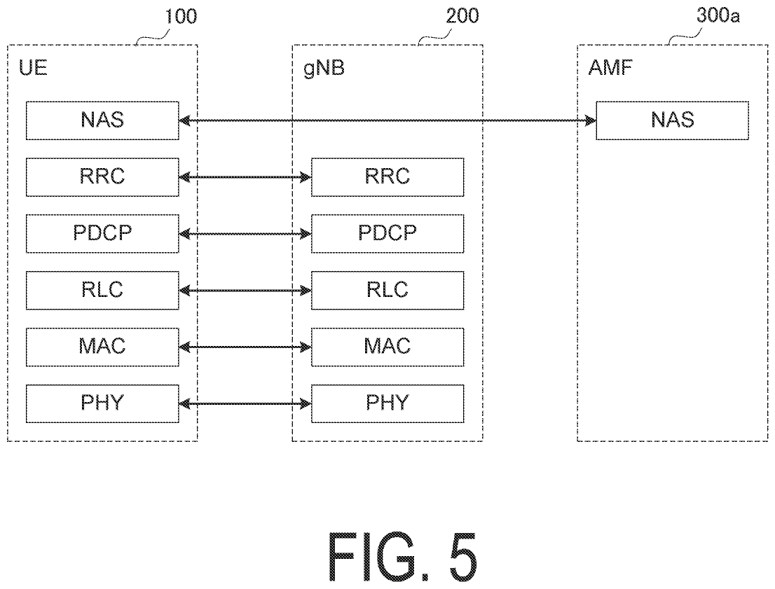

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of the AMF 300.

Note that the UE 100 includes an application layer other than the protocol of the radio interface.

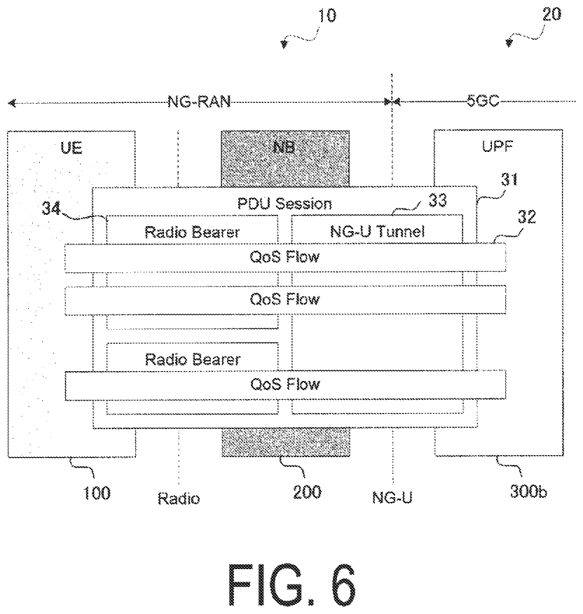

FIG. 6 is a diagram illustrating Quality of Service (QoS) control in the mobile communication system 1 (see 3GPP TS38. 300).

As illustrated in FIG. 6, in the mobile communication system 1 in 5GS, QoS control can be performed in units of a QoS flow 32 in order to enable more flexible and detailed QoS control. A plurality of QoS flows 32 is provided in one PDU session 31 established between UE 100 and UPF 300b. At the NAS level, the QoS flow 32 is the finest granularity of QoS control in the PDU session 31. The QoS flow 32 is identified within the PDU session 31 by a QoS Flow ID (QFI) carried in the encapsulating header in an NG-U tunnel 33 between gNB (NB) and UPF 300b.

At the AS level between the UE 100 and gNB 200 (NG-RAN 10), QoS control is performed in units of a radio bearer (Data Radio Bearer (DRB)) 34. The SDAP layer of each of the UE 100 and the gNB 200 performs mapping between the QoS flow 32 and the radio bearer 34. Specifically, the SDAP layer encapsulates an IP packet and notifies a corresponding QFI in a header of the IP packet (SDAP header).

In this way, the NG-RAN 10 and the 5GC 20 ensure quality-of-service (such as reliability and/or target delay) by mapping packets to appropriate QoS flows and DRBs. Therefore, mapping is provided at two stages (AS): mapping from the IP-flow to the QoS flow 32 (NAS) and mapping from the QoS flow 32 to the DRB 34 mapping.

At the AS level, the data radio bearer (DRB) 34 defines packet processing on the radio interface (Uu). One DRB 34 processes packets in the same packet forwarding processing. The mapping of the QoS flow 32 to the DRB 34 by the NG-RAN 10 is based on the QFI and an associated QoS profile (i.e., QoS parameters and QoS characteristics). Individual DRBs 34 may be established for the QoS flows 32 requiring different packet forwarding processing operations, or a plurality of QoS flows 32 belonging to the same PDU session 31 may be multiplexed into the same DRB 34.

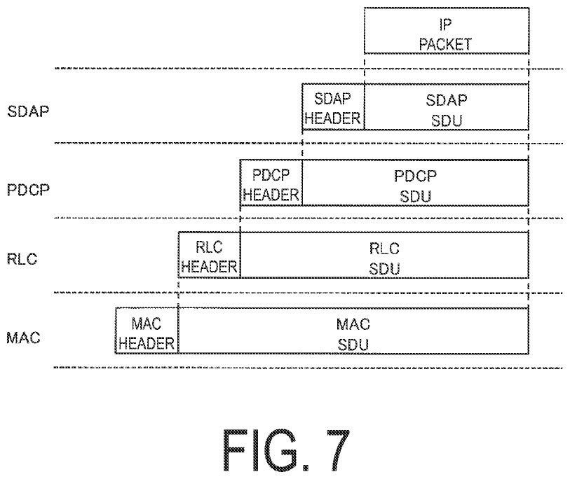

FIG. 7 is a diagram illustrating an example of processing of each layer in the protocol stack of the radio interface of the user plane.

First, processing on the transmission side will be described. A transmission-side SDAP entity that is an entity of the SDAP layer on the transmission side receives, as an SDAP SDU, an IP packet to be transmitted to the reception side, performs transmission processing of the SDAP layer, assigns an SDAP header to the SDAP SDU to generate an SDAP PDU, and outputs the SDAP PDU to a lower layer.

A transmission-side PDCP entity, that is an entity of the PDCP layer on the transmission side, receives the SDAP PDU as a PDCP SDU, performs transmission processing of the PDCP layer, assigns a PDCP header to the PDCP SDU to generate a PDCP PDU, and outputs the PDCP PDU to a lower layer.

A transmission-side RLC entity, that is an entity of the RLC layer on the transmission side, receives the PDCP PDU as an RLC SDU, performs transmission processing of the RLC layer, assigns an RLC header to the RLC SDU to generate an RLC PDU, and outputs the PDCP PDU to a lower layer.

A transmission-side MAC entity, that is an entity of the MAC layer on the transmission side, receives the RLC PDU as a MAC SDU, performs transmission processing of the MAC layer, assigns a MAC header to the MAC SDU to generate a MAC PDU, and outputs the PDCP PDU to a lower layer.

Second, processing on the reception side will be described. A reception-side MAC entity that is an entity of the MAC layer on the reception side receives the MAC PDU from the lower layer, performs reception processing of the MAC layer based on the MAC header, removes the MAC header, and outputs the MAC SDU to the upper layer.

A reception-side RLC entity that is an entity of the RLC layer on the reception side, receives the MAC SDU from the lower layer as an RLC PDU, performs reception processing of the RLC layer based on the RLC header, removes the RLC header, and outputs the RLC SDU to the upper layer.

A reception-side PDCP entity that is an entity of the PDCP layer on the reception side, receives the RLC SDU from the lower layer as an PDCP PDU, performs reception processing of the PDCP layer based on the PDCP header, removes the PDCP header, and outputs the PDCP SDU to the upper layer.

A reception-side SDAP entity that is an entity of the SDAP layer on the reception side receives the PDCP SDU from the lower layer as an SDAP PDU, performs reception processing of the SDAP layer based on the SDAP header, removes the SDAP header, and outputs the SDAP SDU (IP packet) to the upper layer.

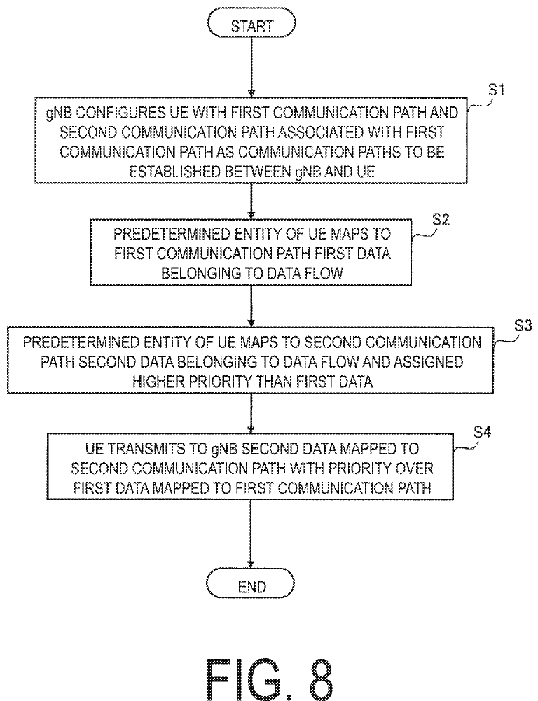

With reference to FIG. 8, operations of the mobile communication system 1 according to an embodiment will be described. Although the mobile communication system 1 has the capability of transmitting TCP data at a high throughput in the downlink, there is a problem with the mobile communication system 1 in that the throughput of the downlink decreases when the transmission of the TCP Ack in the uplink is delayed due to how TCP works. The following describes an operation of enabling transmitting specific data (for example, the TCP Ack) with priority over other data in the uplink.

As illustrated in FIG. 8, in step S1, the gNB 200 configures the UE 100 with a first communication path and a second communication path associated with the first communication path as communication paths to be established between the gNB 200 and the UE 100. Here, the gNB 200 may transmit, to the UE 100, an RRC message including information associating the first communication path with the second communication path.

In step S2, an entity in a predetermined layer of the UE 100 (hereinafter referred to as a “predetermined entity”) maps, to the first communication path, first data belonging to a data flow.

In step S3, the predetermined entity of the UE 100 maps, to the second communication path, second data belonging to the data flow and being assigned a higher priority than the first data. The second data may be a TCP Ack.

The predetermined layer may be an SDAP layer. In other words, the predetermined entity may be an SDAP entity (transmission-side SDAP entity) of the UE 100. The first communication path may be a Normal DRB, and the second communication path may be a Prioritized DRB associated with the Normal DRB.

Alternatively, the predetermined layer may be a PDCP layer. In other words, the predetermined entity may be a PDCP entity (transmission-side PDCP entity) of the UE 100. The first communication path may be a Normal leg of a split bearer. The second communication path may be a Prioritized-leg of the split bearer.

In step S4, the UE 100 transmits, to the gNB 200, the second data mapped to the second communication path with priority over the first data mapped to the first communication path. For example, the MAC-entity of the UE 100 (transmission-side MAC-entity) performs processing (Logical Channel Prioritization (LCP)) of prioritizing the second logical channel associated with the second communication path over the first logical channel associated with the first communication path. Generally, parameters for LCP processing are configured for the UE 100 by the gNB 200.

Thus, specific data (for example, the TCP Ack) can be transmitted in the uplink with priority over the other data. Therefore, high throughput can be achieved in the mobile communication system 1.

In the UE 100 according to an embodiment, the receiver 110 receives, from the gNB 200, information indicating configuration of the first communication path and the second communication path associated with the first communication path as communication paths to be established between the gNB 200 and the UE 100. The controller 130 maps, to the first communication path, the first data belonging to the data flow, and maps, to the second communication path, the second data belonging to the data flow and being assigned a higher priority than the first data. The transmitter 120 transmits, to the gNB 200, the second data mapped to the second communication path with priority over the first data mapped to the first communication path.

In the gNB 200 according to an embodiment, the controller 230 configures the UE 100 with the first communication path and the second communication path associated with the first communication path as communication paths to be established between the gNB 200 and the UE 100. The transmitter 210 may transmit, to the UE 100, an RRC message including information associating the first communication path with the second communication path. The receiver 220 receives, from the UE 100, the first data mapped to the first communication path and the second data mapped to the second communication path. Here, the first data and the second data are data belonging to the same data flow. The second data mapped to the second communication path is transmitted from the UE 100 with priority over the first data mapped to the first communication path.

The second data transmitted with priority over the first data in the uplink is not limited to the TCP Ack, and data of a type designated by the gNB 200 may be used as the second data. For example, gNB 200 configures the UE 100 with the data type to be mapped to the second communication path. The predetermined entity of the UE 100 maps the configured type of data to the second communication path as the second data. This enables control with a higher degree of freedom.

As described above, according to an embodiment, the specific data (for example, the TCP Ack) can be transmitted with priority over the other data in the uplink. Thus, high throughput can be achieved in the mobile communication system 1.

### Example

Given the embodiment described above, a first and a second example are described. These examples can not only be separately and independently implemented, but can also be implemented in combination of two or more thereof. In an operation flow of each example described below, all the steps may not be necessarily performed, and only a part of the steps may be performed. In the operation flow of each example described below, the order of the steps may be changed.

### (1) First Example

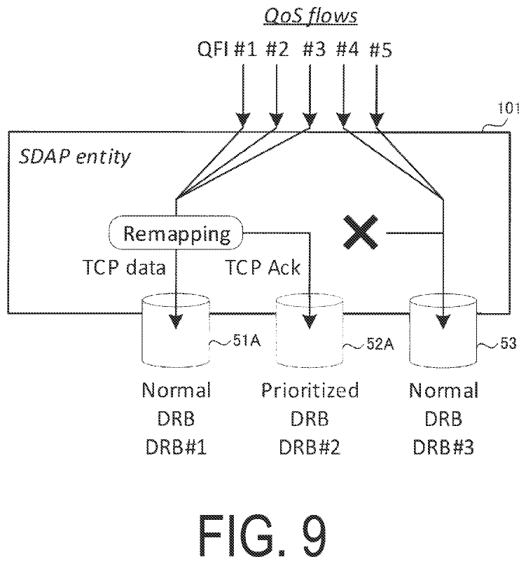

FIG. 9 is a diagram illustrating an SDAP entity 101 according to a first example. In the first example, the predetermined entity of the UE 100 is the SDAP entity 101 of the UE 100, the first communication path is a Normal DRB 51A, and the second communication path is a Prioritized DRB 52A associated with the Normal DRB 51A.

Five QoS flows have been input to the SDAP entity 101 of the UE 100. An individual QFI is assigned to each QoS flow, and five QFIs (QFIs #1 to #5) are assigned to the five QoS flows.

The SDAP entity 101 of the UE 100 maps the three QoS flows with QFIs #1 to #3 to the Normal DRB 51A according to the configuration from the gNB 200. The Normal DRB 51A is assigned “#1” as a DRB ID. The SDAP entity 101 maps the two QoS flows with QFIs #4 and #5 to a Normal DRB 53 according to the configuration from the gNB 200. The Normal DRB 53 is assigned “#3” as a DRB ID.

The Prioritized DRB 51A is associated with the Normal DRB 52A according to the configuration from the gNB 200. The Prioritized DRB 52A is assigned “#2” as a DRB ID.

The SDAP entity 101 of the UE 100 maps and outputs, to the Normal DRB 51A, the first data (e.g., TCP data other than the TCP Ack) belonging to the three QoS flows with QFIs #1 to #3. The SDAP entity 101 of the UE 100 maps and outputs, to the Prioritized DRB 52A, the second data (e.g., TCP Ack) belonging to the three QoS flows. Here, the mapping to the Prioritized DRB 52A means that the Prioritized DRB 52A is reassigned the data of the QoS flow assigned to the Normal DRB 51A according to the configuration from the gNB 200. Accordingly, such mapping may be referred to as remapping. Thus, the second data (for example, the TCP Ack) can be transmitted with priority.

Here, among the three QoS flows with QFIs #1 to #3, the QoS flow that enables mapping to the Prioritized DRB 52A may be configured by the gNB 200. For example, among the three QoS flows with QFIs #1 to #3, the two QoS flows with QFIs #1 and #2 may be allowed to be mapped to the Prioritized DRB 52A, whereas the QoS flow with QFI #3 may be prohibited from being mapped to the Prioritized DRB 52A. Thus, whether the Prioritized DRB 52A is applicable can be flexibly configured for each QoS flow.

The SDAP entity 101 of the UE 100 may generate one SDAP PDU including two or more TCP Acks belonging to two or more QoS flows, and map and output the SDAP PDU to the Prioritized DRB 52A. Specifically, the Remapping function of the SDAP entity 101 may concatenate a plurality of TCP Ack packets of a plurality of QoS flows, generate an SDAP header including the QFI of each of the plurality of QoS flows, and generate one SDAP PDU having the concatenated plurality of TCP Ack packets and the SDAP header. This allows the TCP Ack to be efficiently transmitted.

Note that the Prioritized DRB 52A may be associated with exclusively one Normal DRB 51A. For example, two QoS flows with QFIs #4 and #5 assigned to the Normal DRB 53 are prohibited from being mapped to the Prioritized DRB 52A.

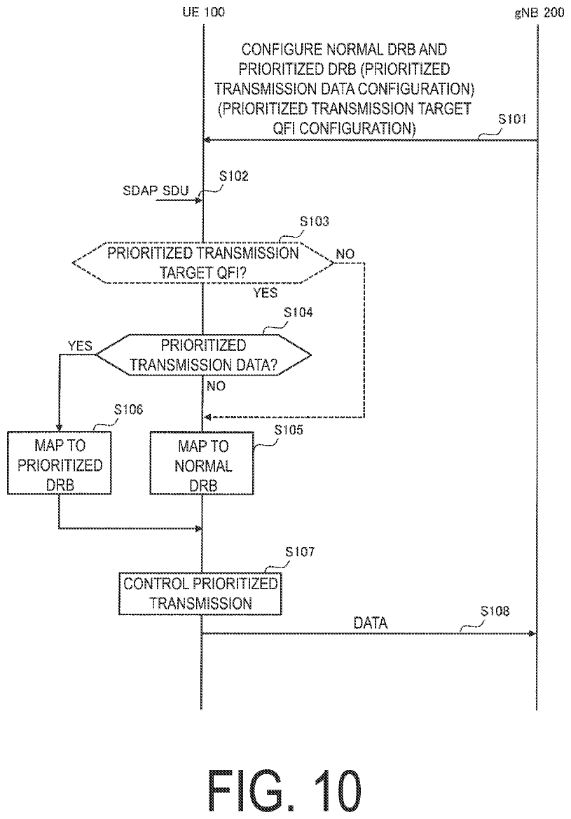

FIG. 10 is a diagram illustrating operations of the gNB 200 and the UE 100 of the first example.

In step S101, the gNB 200 configures the UE 100 with a mapping rule. To be specific, the gNB 200 configures the UE 100 with a special DRB (Prioritized DRB 52A). The gNB 200 configures the UE 100 with the Normal DRB 51A that can map data to the Prioritized DRB 52A. In other words, the gNB 200 allows the UE 100 to remap, to the Prioritized DRB 52A, the data mapped to the Normal DRB 51A. The gNB 200 may configure the UE 100 with association information between the DRB ID “#1” of the Prioritized DRB 52A and the DRB ID “2” of the Normal DRB 51A. The configuration in step S101 may be performed using a UE-dedicated RRC message, for example, an RRC Reconfiguration message, transmitted from the gNB 200 to the UE 100. The UE 100 receives the RRC message including the configuration information from the gNB 200.

In step S101, the gNB 200 may configure the UE 100 with the data type of IP packet that can be mapped (remapped) to the Prioritized DRB 52A (or that is allowed to be mapped to the Prioritized DRB 52A) (prioritized transmission data configuration). For example, the gNB 200 may configure the TCP Ack as the data type. For example, the gNB 200 may configure User Datagram Protocol (UDP) data.

In step S101, the gNB 200 may configure the UE 100 with a QFI (QoS flow) that can be mapped to the Prioritized DRB 52A (prioritized transmission data target QFI configuration). For example, when any of QFIs #1 to #3 is mapped to the Normal DRB 51A, the gNB 200 may configure the UE 100 with the fact that GFIs #1 and #2 can be mapped to the Prioritized DRB 52A.

In step S102, the SDAP entity 101 of the UE 100 receives the SDAP SDU (that is, IP packet) from the higher layer. Note that the SDAP SDU is not limited to the IP packet and may be an industrial Ethernet packet or the like. Hereinafter, an example in which the SDAP SDU is an IP packet will be described. The QFI of the QoS flow to which the SDAP SDU (IP packet) belongs is associated with the DRB ID of the Normal DRB according to the mapping rule.

In step S103, the SDAP entity 101 of the UE 100 may determine whether the QFI of the QoS flow to which the SDAP SDU received in step S102 belongs is configured as a QFI (QoS flow) that can be mapped to the Prioritized DRB 52A. When the QFI can be mapped to the Prioritized DRB 52A (step S103: YES), the processing proceeds to step S104. On the other hand, when the QFI cannot be mapped to the Prioritized DRB 52A (step S103: NO), the processing proceeds to step S105. Step S103 is not essential for the operations of the UE 100 in FIG. 10.

In step S104, the SDAP entity 101 of the UE 100 determines whether the SDAP SDU received in step S102 is prioritized transmission data to be transmitted with priority. The prioritized transmission data may be data of a predefined type (for example, the TCP Ack). The prioritized transmission data may be data of a type configured by the gNB 200 in step S101.

The SDAP entity 101 of the UE 100 may perform deep packet inspection (DPI) or the like to determine whether the SDAP SDU is prioritized transmission data. The SDAP entity 101 of the UE 100 can determine the TCP Ack by performing header analysis on the SDAP SDU (IP packet). For example, the SDAP entity 101 of the UE 100 may determine that the packet is a TCP packet when the “Protocol” field of the IP-header is “6”. Alternatively, the SDAP entity 101 of the UE 100 may determine that the packet is a TCP Ack packet when an “ACK” bit in a “control flag” of the TCP header is “1”.

When the SDAP SDU received in step S102 is determined not to be prioritized transmission data (step S104: NO), in step S105, the SDAP entity 101 of the UE 100 maps the SDAP SDU to the Normal DRB 51A and outputs, to the Normal DRB 51A, the SDAP PDU including the SDAP SDU.

On the other hand, when the SDAP SDU received in step S102 is determined to be prioritized transmission data (step S104: YES), in step S106, the SDAP entity 101 of the UE 100 maps the SDAP SDU to the Prioritized DRB 52A and outputs, to the Prioritized DRB 52A, the SDAP PDU including the SDAP SDU. Here, the remapping function of the SDAP entity 101 may generate one SDAP PDU by concatenating a plurality of TCP Ack packets (a plurality of SDAP SDUs) of a plurality of QoS flows. At this time, by including the QFIs of the plurality of SDAP SDUs in the SDAP header, the plurality of QFI may be notified using the SDAP header.

Note that The SDAP entity 101 of UE 100 may assign the SDAP header according to the configuration from the gNB 200 in both of steps S105 and S106. Even with no configuration for assignment of the SDAP header, the SDAP entity 101 of the UE 100 may always assign the SDAP header in order for the receiving side to know the QFI of each packet when a plurality of QoS flows is remapped to the Prioritized DRB 52A.

In steps S107 and S108, the lower layer of the UE 100 (in particular, the MAC-entity) transmits the data mapped to the Prioritized DRB 52A with priority over the other DRBs. For example, in the LCP, the MAC entity may treat the data mapped to the Prioritized DRB 52A as the highest priority. Note that the gNB 200 may configure the priority. The gNB 200 receives the data mapped to the Prioritized DRB 52A.

### (2) Second Example

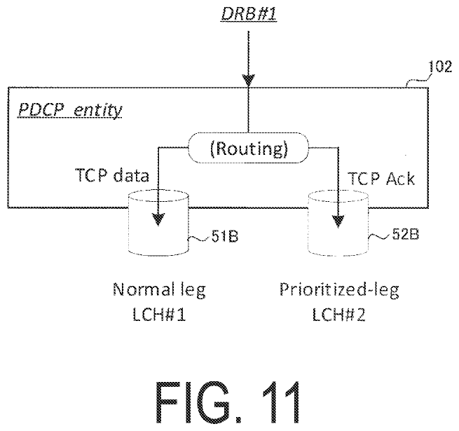

FIG. 11 is a diagram illustrating a PDCP entity 102 in a second embodiment. In the second embodiment, the predetermined entity of the UE 100 is a PDCP entity 102 of the UE 100, the first communication path is a Normal leg 51B of the split bearer, and the second communication path is a Prioritized-leg 52B of the split bearer. Note that the legs may be RLC channels. The legs may be logical channels.

One DRB (DRB #1) corresponding to one data flow is input to the PDCP entity 102 of the UE 100. The PDCP entity 102 of the UE 100 forms a split bearer by splitting DRB #1 into the Normal leg 51B and the Prioritized-leg 52B according to the configuration from the gNB 200. The Normal leg 51B is assigned “#1” as a logical channel (LCH) ID. The Prioritized-leg 52B is assigned “#2” as an LCH ID. Note that three or more legs may be provided.

The PDCP entity 102 of the UE 100 maps (routes) and outputs, to the Normal leg 51B, the first data (e.g., TCP data other than the TCP Ack) belonging to the DRB #1. The PDCP entity 102 of the UE 100 maps (routes) and outputs, to the Prioritized-leg 52B, the second data (e.g., the TCP Ack) belonging to the DRB #1.

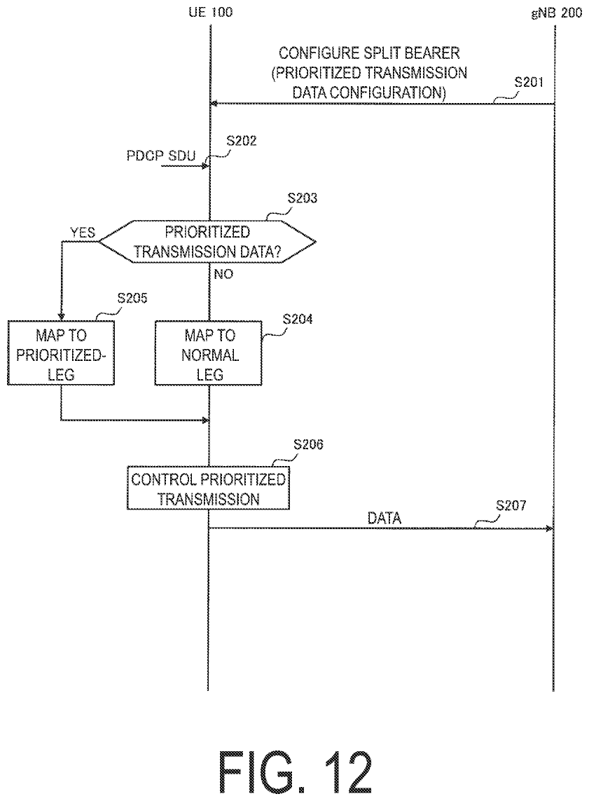

FIG. 12 is a diagram illustrating operations of the gNB 200 and the UE 100 according to the second example.

In step S201, the gNB 200 configures the UE 100 with the split bearer. The configuration may include identification information of the Normal leg 51B and/or the Prioritized-leg 52B. The configuration may include a data type that can be mapped (routed) to the Prioritized-leg 52B. The configuration in step S201 may be performed using a UE-dedicated RRC message transmitted from the gNB 200 to the UE 100, for example, an RRC Reconfiguration message. The UE 100 receives the RRC message including the configuration information from the gNB 200.

Here, the identification information of the Normal leg 51B and/or the Prioritized-leg 52B may be associated with the entire split bearer (for example, “TCP Ack prioritization=true”). The identification information may be associated with each leg. The identification information may be associated with each RLC channel (RLC bearer/RLC entity). The identification information may be associated with each LCH.

In step S202, the PDCP entity 102 of the UE 100 receives a PDCP SDU (e.g., the PDCP SDU belonging to the DRB #1) from the SDAP entity.

In step S203, the PDCP entity 102 of the UE 100 determines whether the PDCP SDU received in step S202 is prioritized transmission data to be transmitted with priority. The prioritized transmission data may be data of a predefined type (for example, the TCP Ack). The prioritized transmission data may be data of a type configured by the gNB 200 in step S101. Note that the SDAP entity may determine whether the PDCP SDU is prioritized transmission data or determine the data type, and the SDAP entity may notify the PDCP entity 102 of the determination result. A method of determining prioritized transmission data is the same as, and/or similar to, that in the first embodiment described above. The PDCP entity may perform the determination of whether the PDCP SDU is the prioritized transmission data or the determination of the data type. For the method of determining prioritized transmission data, a method the same as, and/or similar to, that in the first embodiment described above is applicable.

When the PDCP SDU received in step S202 is determined not to be prioritized transmission data (step S203: NO), in step S204, the PDCP entity 102 of the UE 100 maps (routes) the PDCP SDU to the Normal leg 51B and outputs, to the Normal leg 51B, the PDCP PDU including the PDCP SDU.

On the other hand, when the PDCP SDU received in step S202 is determined to be prioritized transmission data (step S203: YES), in step S205, the PDCP entity 102 of the UE 100 maps (routes) the PDCP SDU to the Prioritized-leg 52B and outputs, to the Prioritized-leg 52B, the PDCP PDU including the PDCP SDU.

In steps S206 and S207, the lower layer of the UE 100 (in particular, the MAC-entity) transmits the data mapped to the Prioritized-leg 52B with priority over the other legs. For example, in the LCP, the MAC entity may treat the data mapped to the Prioritized-leg 52B as the highest priority. Note that the gNB 200 may configure the priority. The gNB 200 receives the data mapped to the Prioritized-leg 52B.

### Other Embodiments

The operation flows described above can be separately and independently implemented, and also be implemented in combination of two or more of the operation flows. For example, some of the steps in one operation flow may be applied to another operation flow. Some of the steps of one operation flow may be replaced with some of the steps of another operation flow.

In the embodiment and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a Distributed Unit (DU) of the IAB node. The user equipment may be a Mobile Termination (MT) of the IAB node. Although a Uu link (communication between the base station and the UE) has been described as an example in the above embodiment and examples, the embodiment and examples may be applied to a sidelink (direct communication between UEs). The embodiment and examples described above may be applied to a sidelink relay UE using the sidelink.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on” used in the present disclosure do not mean “based only on” and “only depending on”, unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### REFERENCE SIGNS

1: Mobile communication system
31: PDU session
32: QoS flow
33: NG-U tunnel
34: Radio bearer
51A: Normal DRB
52A: Prioritized DRB
51B: Normal leg
52B: Prioritized-leg
53: Normal DRB
101: SDAP entity
102: PDCP entity
100: UE
110: Receiver
120: Transmitter
130: Controller
200: gNB
210: Transmitter
220: Receiver
230: Controller
240: Backhaul communicator

1. A communication method used in a mobile communication system, the communication method comprising the steps of:
configuring, by a network node, a user equipment with a first communication path and a second communication path associated with the first communication path as communication paths to be established between the network node and the user equipment;
mapping, by an entity in a predetermined layer of the user equipment, first data belonging to a data flow to the first communication path;
mapping, by the entity to the second communication path, second data belonging to the data flow and being assigned a higher priority than the first data; and
transmitting, by the user equipment to the network node, the second data mapped to the second communication path with priority over the first data mapped to the first communication path.

2. The communication method according to claim 1, wherein the second data is a Transmission Control Protocol Acknowledgement (TCP Ack).

3. The communication method according to claim 1, further comprising:
configuring, by the network node, the user equipment with a type of data to be mapped to the second communication path, wherein
the mapping to the second communication path comprises mapping the data of the configured type to the second communication path as the second data.

4. The communication method according to claim 1, wherein the configuring comprises transmitting, from the network node to the user equipment, an RRC message comprising information associating the first communication path with the second communication path.

5. The communication method according to claim 1, wherein
the predetermined layer is a Service Data Adaptation Protocol (SDAP) layer, and
the data flow is a QoS flow,
the first communication path is a Normal Data Radio Bearer (DRB), and
the second communication path is a Prioritized DRB associated with the Normal DRB.

6. The communication method according to claim 5, wherein
the mapping to the first communication path comprises mapping, to the normal DRB, the first data belonging to a plurality of QoS flows, and
the mapping to the second communication path comprises mapping, to the Prioritized DRB, the second data belonging to at least one QoS flow among the plurality of QoS flows.

7. The communication method according to claim 6, further comprising:
configuring, by the network node, the user equipment with the at least one QoS flow enabling mapping to the Prioritized DRB.

8. The communication method according to claim 6, wherein
the second data is a TCP Ack, and
the mapping to the second communication path comprises mapping, to the second communication path, one SDAP Protocol Data Unit (PDU) comprising two or more TCP Acks belonging to two or more QoS flows among the plurality of QoS flows.

9. The communication method according to claim 1, wherein
the predetermined layer is a Packet Data Convergence Protocol (PDCP) layer, and
the first communication path is a Normal leg of a split bearer, and
the second communication path is a Prioritized-leg of the split bearer.

10. The communication method according to claim 9, wherein the configuring comprises configuring the user equipment with the split bearer.

11. A user equipment used in a mobile communication system, the user equipment comprising:
a receiver configured to receive, from a network node, information indicating configuration of a first communication path and a second communication path associated with the first communication path as communication paths to be established between the network node and the user equipment;
a controller configured to map, to the first communication path, first data belonging to a data flow and to map, to the second communication path, second data belonging to the data flow and being assigned a higher priority than the first data; and
a transmitter configured to transmit, to the network node, the second data mapped to the second communication path with priority over the first data mapped to the first communication path.

12. A network node used in a mobile communication system, the network node comprising:
a controller configured to configure a user equipment with a first communication path and a second communication path associated with the first communication path as communication paths to be established between the network node and the user equipment; and
a receiver configured to receive, from the user equipment, first data mapped to the first communication path and second data mapped to the second communication path, wherein
the first data and the second data are data belonging to the same data flow, and
the second data mapped to the second communication path is transmitted from the user equipment with priority over the first data mapped to the first communication path.
